(19) United States
(12) Patent Application Publication
(10) Pub. No.: US 2019/0254259 A1
(43) Pub. Date: Aug. 22, 2019

(54) POULTRY TRANSPORT SYSTEM AND METHOD

(71) Applicants: Everett Waid, Fort Myers, FL (US); Tim Youngquist, Fort Myers, FL (US); John M. Brown, Fort Myers, FL (US)

(72) Inventors: Everett Waid, Fort Myers, FL (US); Tim Youngquist, Fort Myers, FL (US); John M. Brown, Fort Myers, FL (US)

(21) Appl. No.: 16/283,556

(22) Filed: Feb. 22, 2019

Related U.S. Application Data
(60) Provisional application No. 62/633,782, filed on Feb. 22, 2018.
(60) Provisional application No. 62/750,963, filed on Oct. 26, 2018.
(60) Provisional application No. 62/750,974, filed on Oct. 26, 2018.

(51) Int. Cl. A01K 31/00; A01K 45/00; B60P 3/04

(52) U.S. Cl. CPC A01K 31/002; B60P 3/04; A01K 45/005

(57) ABSTRACT

A poultry transport system and method involving at least one frame structure configurable for baseless suspension in which said system and method may include a frame structure top of a first frame structure engageable to a frame structure bottom of a second frame structure to form paired frame structures.

### CROSS-REFERENCE TO RELATED APPLICATIONS

This application is a non-provisional U.S. patent application claiming the benefit of priority to U.S. provisional application No. 62/633,782 filed on Feb. 22, 2018, U.S. provisional application No. 62/750,963 filed on Oct. 26, 2018, and U.S. provisional application No. 62/750,974 filed on Oct. 26, 2018, the contents of which are incorporated herein by reference in their entireties for all purposes.

### FIELD OF THE INVENTION

The present invention relates to poultry transport systems and methods for use.

### BACKGROUND OF THE INVENTION

Poultry transport systems and methods currently exist on the market. These systems and methods generally include frame structures of essentially rectangular boxes with columns and/or rows of cells defined in great part by the outer frame structure often with some type of openwork system allowing air circulation (potentially with braces/struts)—the overall system essentially consisting of an array of integrated cage cells. Older poultry transport systems can have as many as seven (7) load-bearing layers for transporting chickens (other than hatchlings—said hatchlings often being transported in poultry transport systems with many more layers due to hatchlings' diminutive size/height). While individual load-bearing layers may be stacked on top of one another in older poultry transport systems, integrated systems approaching a realistic maximum numbers of layers for non-hatchlings (e.g., seven layers) were not intended to be stacked upon one another.

More modern, integrated, commercial poultry transport systems have generally settled upon frame structures with cells mostly defined by no more than five (5) poultry load-bearing layers divided into either two (2) or three (3) vertical columns. Such cells may be configured with a mostly open side face into which open-top crates/drawers containing poultry can be inserted; and/or each cell can have an associated door either biased or otherwise securable to prevent the unintentional exit of poultry once inserted into a cell for transport. Such modem five (5) layer frame structures are generally stacked no higher than two frame structures high on a transport vehicle (i.e., tractor-trailer generally with a complete platform bed). The current general realistic limit of ten (10) total layers for two stacked frame structures loaded on a transport vehicle is primarily dictated by the expected general size of (non-hatchling) transported poultry as well as safety/legal limitations related to load height and weight. Sometimes, the realistic limit of layers is even less than ten (10), particularly for bigger poultry (e.g., full-grown turkeys). The foregoing, older poultry transport systems generally rely upon lashings or other tie-down methods to prevent a load from shifting excessively during vehicular transport.

Such frame structures can have material at or very near a bottom defining grooves/openings engageable by lifting means (e.g., a forklift and/or the forks of a forklift). The low position of these engageable defined grooves/openings can make them difficult to view during any lifting attempt/operation and require the lifting means to engage the frames structures at a low level (potential at further distances, or along less favorable/unattainable lines of sight, for the lift operator especially if the lift operator is wearing protective equipment like a hardhat and/or if a cab area or the operator utilizes atmospheric protection/enhancement equipment.

Such difficult lines of sight can potentially increase handling mishaps resulting in damage/injury to the frame structure, any poultry contained therein, the lifting means or vehicle being loaded/unloaded, or nearby structures/equipment/persons. Also, by engaging the frame structures at such a low level, during loading/unloading operations, the lifting means often needs to lift the frame structure(s) to considerable heights during loading/unloading operations; the increased pertinent vertical distance component during lifting can result in less of a pertinent horizontal distance component, particularly regarding support members on lifting means that are angled to level ground, resulting in less horizontal clearance (e.g., for tires) between the lifting means and any transport vehicle that is being loaded/unloaded. If a forklift is used as the lifting means, the fork assembly often cannot be conveniently configured to any settings other than those that permits the forks to be at a low position very near ground level to engage grooves/opening near the ground.

Also, a generally complete platform bed (e.g., atop a trailer chassis) can be heavy as well as expensive to install/maintain. Usage of a generally complete platform bed generally decreases the useful load weight during transport. Usage of a generally complete platform bed generally promotes load placement at a level higher than if no complete platform bed were required thereby decreasing the amount of useful load height while raising the centers of gravity for, and decreasing the stability of, the transported load and its associated means of transport. The foregoing tends to lower the amount of useful load, increase the number of required transports for a given weight of poultry, and result in increased fuel, maintenance, and other costs.

Poultry transport cage doors for poultry transport systems and methods for use currently exist on the market. However, these doors generally require labor-intensive and time-consuming efforts to secure or unsecure the poultry transport cage doors during poultry transport operations and transitions (e.g., numerous engagements of eyehook devices). Current transport cage doors for poultry transport systems and methods are generally associated with static cagework/wireworks helping to define cells—each cell holding multiple poultry during transport. Alternatively or additionally, cells may have a mostly open side face through which open-top crates/drawers loaded with poultry may be inserted into cells for transport and removed upon arrival at a destination. Removal is also often labor-intensive and time-consuming requiring each individual poultry to be handled by personnel.

Also, current poultry transport cages includes direct exposure of metal wire to the birds. As the cage ages, and is mishandled, the wires can bend, deform, spread, distort or break. Such breakage and deformation can cause pointed ends that damage/injure the birds. Extensive breakage of the floors can allow the birds to fall through to a different cell/cage, be cut or trapped by the broken floor or escape the cage entirely. Furthermore, cold bare wire can freeze to poultry when grasped and their feet can freeze to the floor causing harm to the bird. Furthermore, poultry can become entangled or otherwise engaged to wireworks thereby requiring more effort to remove them from a cell once they arrive at a destination. It would also be more desirable to provide a structure, such as the structure of the invention disclosed herein, which also helps the birds avoid direct sunlight to keep them cooler in hot weather.

Damage to poultry transport cages currently on the market can lead to costly repairs and/or premature disposal of the poultry transport cage due to wear and tear. Also, organic waste created by poultry during transport can foul the cages requiring extensive cleaning, in part to prevent/hinder the spread of certain poultry diseases. Unchanneled organic waste can also create messy conditions for poultry—especially those in the lower layers.

Also, the cagework/wireworks in current poultry transport cages essentially allows only a slightly impeded view both into and out of the frame structures. As a result, passersby have increased opportunity to potentially form negative impressions of the company transporting the poultry, or to be otherwise deleteriously affected regarding macabre thoughts regarding transported poultry's likely final destination. Additionally, a constantly changing visual pattern can be more stressful to transported poultry versus a mostly blocked visual pattern; any such extra stress can lead to less favorable physiological conditions for transported poultry as well as increased damaging pecking/scratching amongst transported poultry.

Accordingly, for the above reasons and others, there is a need in the industry for improved poultry transport systems and methods.

### SUMMARY OF THE INVENTION

The invention is generally directed to systems and methods which addresses the issues cited above as well as other issues, among other things.

For example, some embodiments of the invention are directed to a poultry transport system and method comprising at least one frame structure configurable for baseless suspension. The at least one frame structure may comprise at least six load-bearing layers. Such a six load-bearing layer system might be especially suited for full-grown broiler chickens; however, certain concepts/embodiments of the current invention could still include fewer load-bearing layers (e.g., perhaps only three or four load-bearing layers for larger poultry such as full-grown turkeys; or perhaps utilizing the more common five load-bearing layers systems currently in the marketplace). The aforementioned system may further include or be dimensioned to be placed upon a transport vehicle comprising at least two frame rails at least some portions of which are separated by a gap wherein the at least one frame structure is configurable for baseless suspension from the at least two frame rails. In some embodiments, the aforementioned system further comprises at least two traversing bars between at least two of the at least two frame rails, said frame rails and at least two traversing members defining at least one loading port configurable for insertion of the bottom of the at least one frame structure.

Some embodiments of the invention are also directed to a poultry transport system comprising: a frame structure configurable to transport poultry comprising; two frame structure sides; two frame structure ends; a frame structure top; a frame structure bottom; openwork joined to the frame structure said openwork configured for permitting airflow, wherein said frame structure and openwork at least partially defines cells configured for containing poultry during transport and at least one cargo port opening leading to a respective associated cell for containing poultry during transport.

In some embodiments of the aforementioned systems, the frame structure further comprises at least six load-bearing layers.

In some embodiments of the aforementioned systems, the frame structure generally defines a rectilinear box.

In some embodiments of the aforementioned systems, the frame structure and/or openwork comprises at least one vertical member dividing the frame structure into at least two columns of cargo port openings with respective row(s) of associated cells. In some embodiments, there are two vertical members dividing the frame structure into three columns of cargo port openings with respective row(s) of associated cells. In some embodiments, a single cell can have more than one door (e.g., one load-bearing layer may have no vertical member dividing the frame structure into columns of cargo port openings with plural doors on said layer).

In some embodiments of the aforementioned systems, the frame structure is configurable to support drawers inserted into respective cargo port openings.

In some embodiments of the aforementioned systems, the frame structure top comprises at least one longitudinal member defining a recess engageable by lifting means. In some embodiments, two such longitudinal members are present with recesses engageable by a two-fork forklift, and the fork assembly may be inverted such that when the fork assembly is at its lowest setting, the forks are still a substantial distance from the ground.

In some embodiments of the aforementioned systems, the frame structure top of one frame structure is shaped and/or otherwise frictionally engageable for pairing with a frame structure bottom of another frame structure thereby forming paired frame structures.

In some embodiments, the aforementioned systems further comprise a door associated with respective cargo port openings wherein the door is configurable to be biased and/or otherwise securable to prevent the unintentional exit of poultry once inserted into a cell for transport.

In some embodiments of the aforementioned systems, the door comprises at least one magnet engageable with the frame structure or other parts associated with the frame structure.

In some embodiments of the aforementioned systems, the door comprises openwork.

In some embodiments of the aforementioned systems, the door comprises a hinge (e.g., a piano hinge or living hinge).

In some embodiments of the aforementioned systems, the door is part of a respective drawer generally insertable into a respective cargo port opening.

In some embodiments of the aforementioned systems, the door is integral with a front section of a poultry transport cage liner.

In some embodiments of the aforementioned systems, the door is comprised of a portion of a poultry transport cage liner.

In some embodiments, the aforementioned systems further comprise a poultry transport cage liner.

In some embodiments of the aforementioned systems, the poultry transport cage liner is comprised of thermally insulating material.

In some embodiments of the aforementioned systems, the poultry transport cage liner comprises a floor section.

In some embodiments of the aforementioned systems, the poultry transport cage liner further comprises at least one wall section.

In some embodiments of the aforementioned systems, the poultry transport cage liner further comprises holes defined by the at least one wall sections.

In some embodiments of the aforementioned systems, drainage slots are defined in the floor section and/or the at least one wall sections.

In some embodiments of the aforementioned systems, the at least one wall section comprises at least two wall sections.

In some embodiments of the aforementioned systems, the at least two wall sections comprises at least four wall sections, wherein the floor section and four wall sections are configurable to form the general shape of an open-top box.

In some embodiments of the aforementioned systems, the poultry transport cage liner further comprises means for fastening at least one wall section to at least one other adjacent wall section. The means for fastening may comprise one or more tabs engageable with at least one other adjacent wall section.

In some embodiments of the aforementioned systems, the poultry transport cage liner comprises a living hinge.

In some embodiments of the aforementioned systems, the door further comprises at least one magnet engageable with the frame structure or other parts associated with the frame structure.

In some embodiments of the aforementioned systems, the poultry transport cage liner is configurable to generally lie within a plane and is foldable to where the at least one wall sections is substantially perpendicular to the floor section.

In some embodiments of the aforementioned systems, the frame structure and/or openworks and/or door may be composed of plastic, other polymers, combined polymers, and/or combined polymeric and non-polymeric materials, suitable for load-bearing adequate to contain and transport poultry. The aforementioned systems may have much/most of their frame structure and/or openworks and/or door composed of lightweight plastic, other combined polymers, and or combined polymeric and non-polymeric materials while other portions of the frame structure and/or openworks and/or door (e.g., outer portions of the frame structure) may be composed of a lightweight metal (e.g., aluminum) components wherein the lightweight metal components have desirable strength/wear qualities.

Some embodiments of the invention are directed to a method for poultry transport comprising the steps of: placing poultry within cells defined within a frame structure; inserting the bottom section of an at least one frame structure through a gap at least partially defined by at least two frame rails comprising part of a transport vehicle; and suspending the frame structure from the at least two frame rails in a baseless configuration.

In some embodiments, the aforementioned method further comprises the step of placing a poultry transport cage liner within a cell within a frame structure.

In some embodiments, the aforementioned method further comprises the step of engaging the top of a first frame structure with the bottom of a second frame structure; in some preferred embodiments at least one of the two engaged frame structures has six levels.

### BRIEF DESCRIPTION OF THE DRAWINGS

Various aspects of the present invention are illustrated by way of example, and not by way of limitation, in the accompanying drawings, wherein;

FIG. 1 depicts a three-dimensional side perspective view emphasizing the outer parameters of a frame structure for the poultry transport system and method of the present invention.

FIG. 2 depicts a three-dimensional end perspective view emphasizing corner extension and two major types of formed recesses—one for engagement by lifting means and one for potentially engaging another frame structure—associated with the top side of a frame structure for the poultry transport system and method of the present invention.

FIG. 3 depicts a three-dimensional side perspective view showing the two-column array and three-column array of defined ports on opposing sides of a frame structure for a poultry transport system and method in accordance with the principles of the present invention.

FIG. 4 is an end perspective view generally emphasizing an end of a frame structure for a poultry transport system and method in accordance with the principles of the present invention.

FIG. 5 is a side perspective view generally emphasizing a side of a frame structure for a poultry transport system and method in accordance with the principles of the present invention.

FIG. 6 is overhead perspective view of a top side for a frame structure generally including some internal structure such as struts for a poultry transport system and method in accordance with the principles of the present invention.

FIG. 7 is an overhead perspective view of an example center frame helping to form the floor of a load-bearing layer including some internal structure such as struts for a poultry transport system and method in accordance with the principles of the present invention.

FIG. 8 is a bottom perspective view of a bottom side for a frame structure generally including internal structure such as struts for a poultry transport system and method in accordance with the principles of the present invention.

FIG. 9 is side perspective of a tractor-trailer loaded with joined and unjoined frame structures for a poultry transport system and method in accordance with the principles of the present invention.

FIG. 10 is an overhead perspective showing of an essentially ladder chassis for a tractor-trailer in an unloaded state and without optional decking over tire and wheel sections.

FIG. 11 depicts a three-dimensional side perspective of a forklift preparing to engage recesses defined by material near the top of a frame structure for the poultry transport system and method of the present invention. In some embodiments (not shown), the fork assembly may be inverted such that when placed in a lowest setting, the associated forks are still a substantial distance above the ground.

FIG. 12 depicts an overhead perspective of an unfolded poultry transport cage liner attachable to a poultry cage door in accordance with the principles of the present invention.

FIG. 13 depicts an overhead perspective of a folded poultry transport cage liner attachable to a poultry cage drawer and/or door in accordance with the principles of the present invention.

FIG. 14 depicts a three-dimensional overhead perspective of the poultry transport cage liner of FIG. 12, with some sides folded (and potentially attached), serving as a poultry transport cage drawer and door for use with a poultry transport in accordance with the principles of the present invention.

FIG. 15 depicts an overhead perspective of a tabbed, unfolded poultry transport cage liner in accordance with the principles of the present invention.

FIG. 16 depicts an overhead perspective of an untabbed, unfolded poultry transport cage liner in accordance with the principles of the present invention.

FIG. 17 depicts a three-dimensional overhead perspective of a poultry transport cage liner of FIG. 15 in accordance with the principles of the present invention.

FIG. 18 depicts a three-dimensional overhead perspective of a folded poultry transport cage liner in accordance with the principles of the present invention.

FIG. 19 depicts a three-dimensional side perspective view of a folded poultry transport cage liner from FIG. 15.

FIG. 20 is three-dimensional top perspective of the poultry transport cage liner in FIG. 16.

FIG. 21 depicts the poultry transport cage liner of FIG. 20 folded and placed into a poultry transport cage in accordance with the principles of the present invention.

FIG. 22 depicts an additional view of the poultry transport cage liner of FIG. 21.

FIG. 23 depicts the attachment of the poultry transport cage liner of FIG. 21 to the poultry transport cage in accordance with the principles of the present invention.

FIG. 24 depicts multiple poultry transport cage liners in a multi-cell poultry cage in accordance with in the principles of the present invention.

FIG. 25 depicts a multi-cell poultry transport cage.

FIG. 26 depicts a perimeter wall of an alternate poultry transport cage liner in accordance with the principles of the present invention.

FIG. 27 depicts an alternate perimeter wall of attached to an interchangeable liner floor in accordance with the principles of the present invention.

FIG. 28 depicts installation of a poultry transport cage liner into a poultry transport cage in accordance with the principles of the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention; additionally, sometimes attention is drawn to the general outer frame structure without depicting other associated structures (e.g., support structures or openworks generally at the boundary of or within space generally defined by the outer parameters of a frame structure).

The following description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by this application. Moreover, nothing disclosed herein is intended to be dedicated to the public regardless of whether such disclosure is explicitly recited in any claim(s). No claim element is to be construed under the provisions of 35 U.S.C. § 112, sixth paragraph, unless the element is expressly recited using the phrase “means for” or, in the case of a method claim, the element is recited using the phrase “step for.”

As will be appreciated by one skilled in the art(s), aspects of the present invention may be embodied as a method, system, or structure. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention; for example, the door, hinge(s), liner, drawer, and magnet(s) of the current invention could be adapted, fitted, or retrofitted in shape, composition, or other aspects so that they work efficiently with poultry cages that already (or will) exist in the marketplace. Aspects of the invention were chosen and described in order to best explain the principles of the invention and the practical application, and to enable others of ordinary skill in the art to understand the invention for various embodiments with various modifications as are suited to the particular use contemplated.

### Some Definitions

“Baseless” and “baselessly” refer to a bottom of a pertinent object not being in a condition upon which it rests upon a base. By way of example, some portion of an object other than the bottom may be supported such that the object hangs or is suspended without its bottom resting upon a platform such as a trailer bed. In some embodiments it may be preferable to utilize a base upon which a bottom may be supported to some extent, and provided that a substantial portion of the weight is supported via the above described hanging and suspension, this is still considered “baseless” or “baselessly”.

“Frame rails” includes not only elongated members but functional equivalents of elongated members even if some portions are curved or are not of a straight-edged nature.

“Load-bearing layer” refers to a generally horizontally orientated layer intended to generally bear the weight of contained and/or transported poultry. Said term is generally not intended to refer to the fact that a frame structure top may directly bear the weight of one frame structure stacked on top of another frame structure.

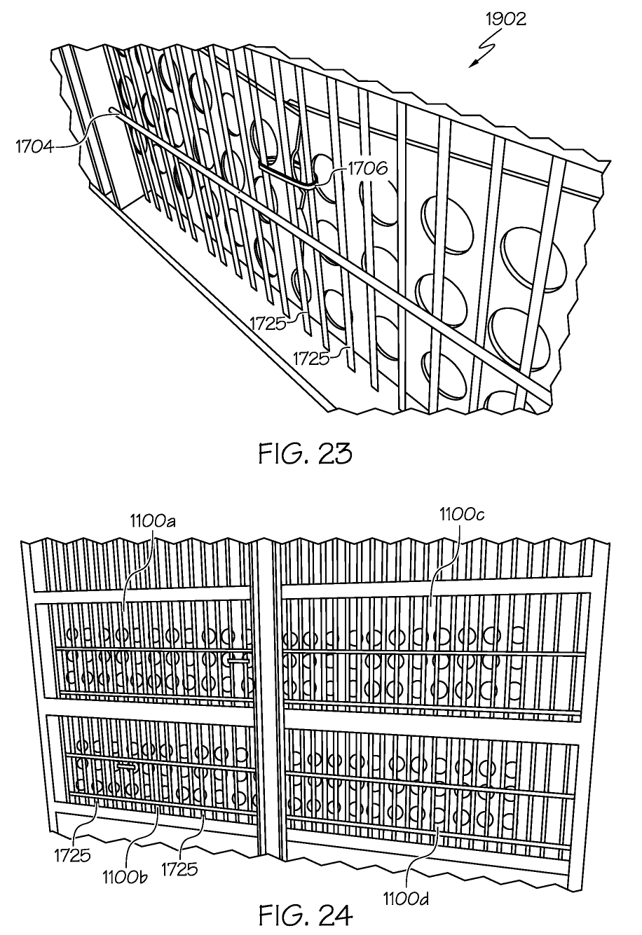

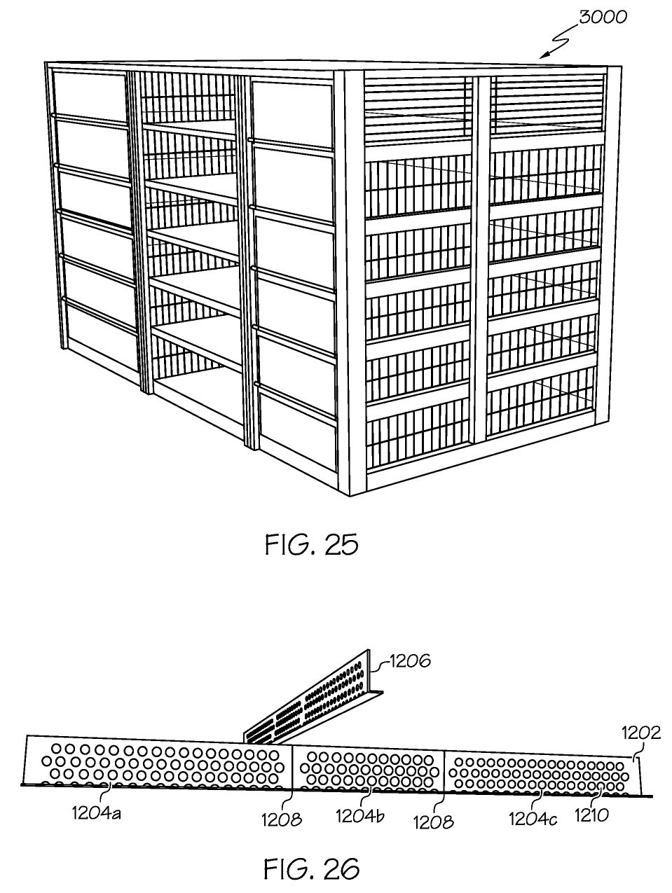

“Poultry transport cage”, when used as a noun, in its narrowest sense, can mean the frame structure of the current invention—potentially with openworks, struts, drawers, doors, and other accoutrements—generally designed to define cells to contain/transport poultry. Occasionally, in a broader sense, the term can include not only the frame structure of the current invention (with potential openworks, struts, drawers, and door) but generically other analogous frame structures with associated accoutrements designed to contain/transport poultry. Examples of two potential embodiments of poultry transport cage are included as reference characters 1902 in FIG. 23 and 3000 in FIG. 25.

“Transport vehicle” includes any vehicle for transporting loads including, but not limited to, an integrated powered vehicle, or a non-powered object (e.g., a trailer chassis and/or partial flatbed) intended to be propelled by or joined to a powered/propelled vehicle.

“Traversing bar” (or “traversing members”) include not only elongated members with square/rectangular cross-sections, but elongated members with any shape of cross-section, and also includes three-dimensional shapes having a cross-section that could otherwise serve as a functional equivalent of a bar (or traversing member) as well as non-straight edged shapes that can otherwise function as a bar (or traversing member).

“Openwork(s)” includes, but is not limited to, cagework, wirework, perforated walls, or any other number of lattices or other similar structure with substantial openings potentially permitting air circulation.

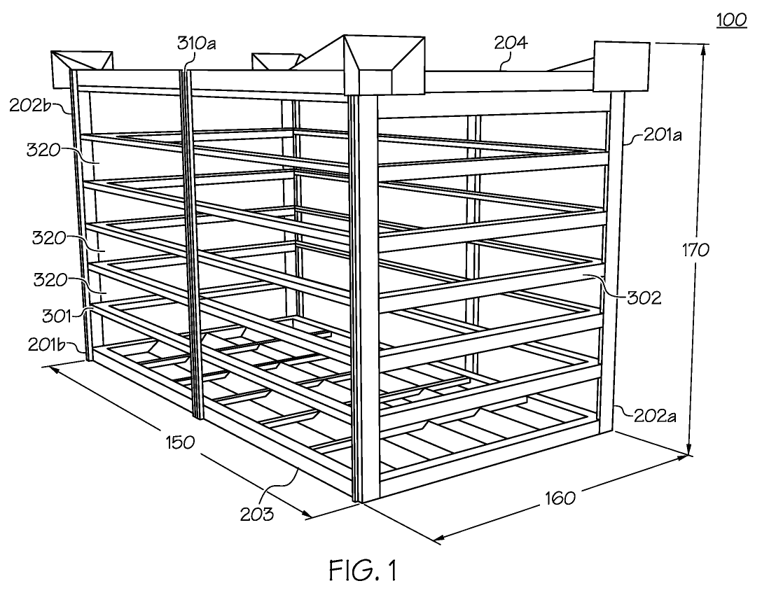

FIG. 1 depicts a three-dimensional diagram of a frame structure 100 having a length 150, a width 160 and height 170. The frame structure 100 has two generally complementary frame structure sides 201a and 201b generally oriented in a plane or plane parallel to both length 150 and height 170. The frame structure has two generally complementary frame structure ends 202a and 202b generally oriented in a plane or plane parallel to both width 160 and height 170. Frame structure 100 has an frame structure bottom 203 generally oriented with a plane parallel to both length 150 and width 160, as well as an opposing frame structure top 204 generally oriented with a plane parallel to the plane to which frame structure bottom 203 is orientated. Frame structure sides 201a and 201b include one or more longitudinal members 301 and one or more vertical members 310a at least partially defining an array of cargo port openings 320 along with material defining the generally rectilinear outline of frame structure 100. FIG. 1 depicts only one such vertical member 310a (for each frame structure side 201a or 201b) which at least partially defines an array of cargo port openings 320 having two columns. Frame structure ends 202a and 202b include one or more traversing members 302.

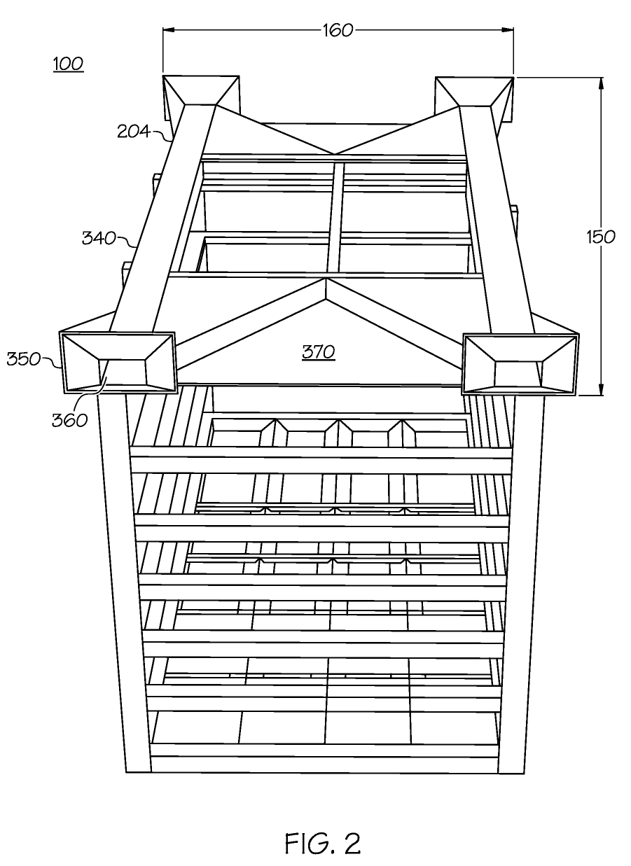

FIG. 2 emphasizes a frame structure top 204 of a frame structure 100 with length 150 and width 160. Frame structure top 204 includes one or more generally identical or complementary longitudinal bars 340 each of which may define one or more generally identical or complementary shaped corners 350, as well as one or more defined lift ports 360 preferably extending a significant distance within a longitudinal bar 340. The material of frame structure top 204 may also define one or more shaped partial recesses 370 at least partially engageable with protruding material on frame structure bottom 203 of a second frame structure 100. Shaped corners 350 may be shaped to bias or guide a second frame structure 100 placed improperly or imprecisely upon a first frame structure 100 towards a more desirable position preferably via gravitational force. In addition to engaging, biasing, and/or guiding to favorably contact the frame structure bottom 203 of a frame structure 100 with the frame structure top 204 of another frame structure 100, two frame structures 100 can be further paired by fastening means.

In other embodiments any number of combinations of recesses or protuberances could be utilized on a frame structure top 204 of a frame structure 100, which at least in part might be complemented by engageable recess or protuberances on a frame structure bottom 203 of another frame structure 100. Also, the defined lift ports 360 are not limited to a frame structure top 204 of a frame structure 100 provided it is a substantial distance from frame structure bottom 203. Nor are the lift ports 360 limited to only be formed by longitudinal bars 340 orientated with length 150 but could, among other things, be orientated with the width 160 of a frame structure 100 such that lifting means might favorably engage a frame structure from a frame structure side 201a or 201b rather than on a frame structure end 202a or 202b. Nor is the invention limited to two longitudinal bars 340 depicted (e.g., each frame structures 100 might have just one longitudinal bar 340 positioned to allow two joined and/or adjacent frame structures 100 to be lifted simultaneously even if it be with two or more forks for adjacent frame structures).

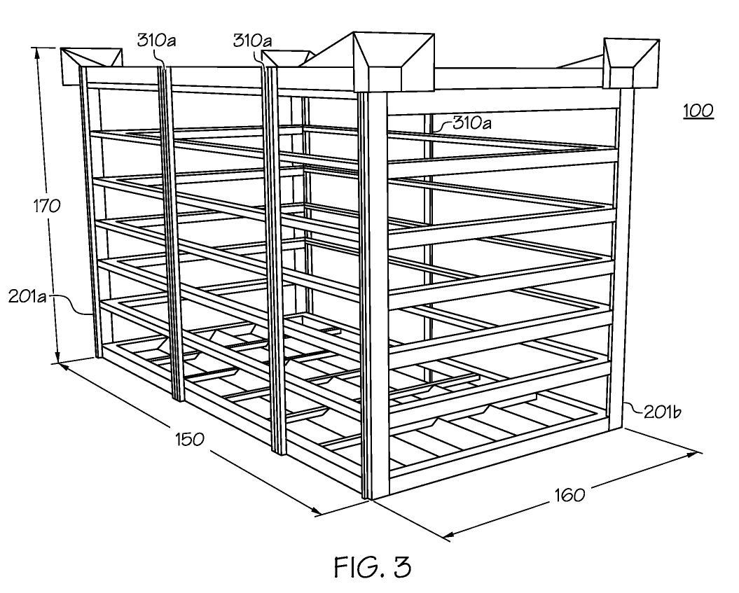

FIG. 3 depicts a preferred embodiment of the present invention in which frame structure 100 has two frame structure sides 201a and 201b. Frame structure side 201b includes only one vertical member 310a at least partially defining an array with two columns of cargo port openings 320; while opposing side 201a includes two vertical members 310a at least partially defining an array with three columns of cargo port openings 320.

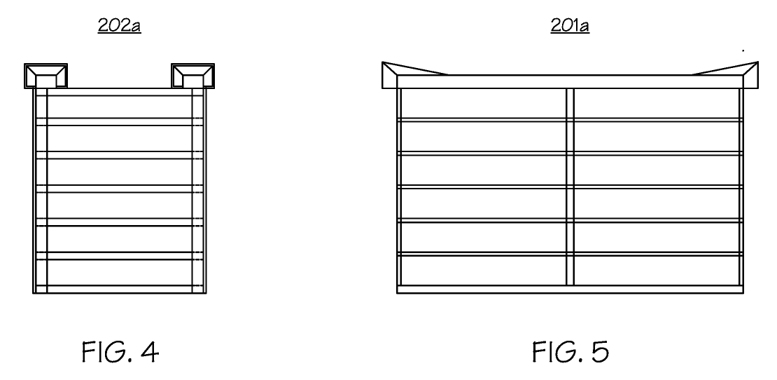

FIG. 4 is an end perspective drawing of a frame structure end 202a.

FIG. 5 is a side perspective drawing of a frame structure side 201a.

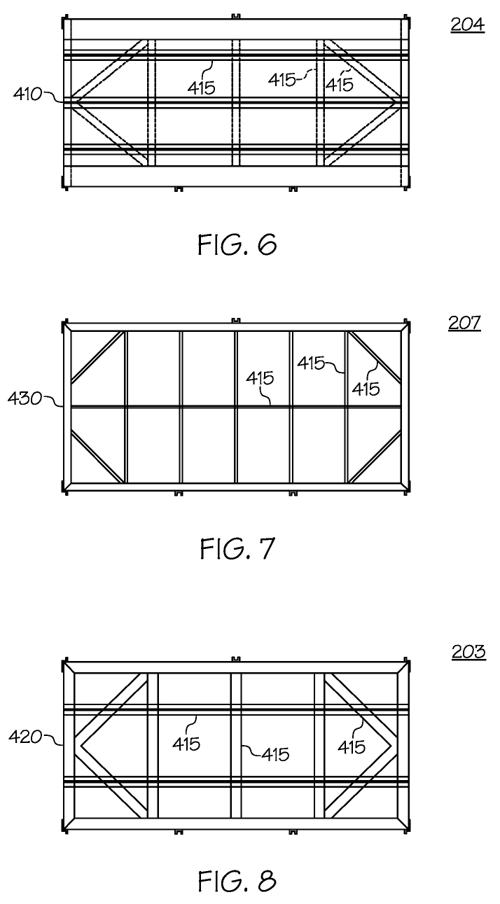

The outside parameters of the frame structure top 204, center frame 207, and/or frame structure bottom 203 of FIGS. 6-8 may be formed by longitudinal members 301 and traversing members 302 and/or be attached be connecting means to same.

FIG. 6 is top perspective drawing of a top surface 410 of frame structure top 204 showing optional struts 415 running the length/width of (or diagonally within) frame structure top 204 for providing strength/stability to frame structure 100 or its associated parts

FIG. 7 is a top perspective drawing of a top surface 430 of a center frame 207 showing optional struts 415 running the length/width of (or diagonally within) a center frame 207 for providing strength/stability to frame structure 100 or its associated parts. A frame structure can include multiple layers of center frames 207 (generally five for a six-layer frame structure) situated between the top surface 410 of FIG. 6 and the bottom surface 420 of FIG. 8.

FIG. 8 is a bottom perspective drawing of bottom surface 420 of frame structure bottom 203 showing optional struts 415 running the length/width of (or diagonally within) a frame structure bottom 203 for providing strength/stability to frame structure 100 or its associated parts.

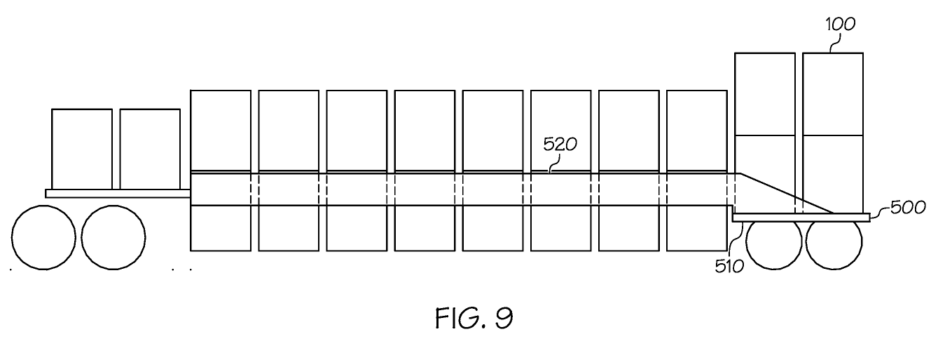

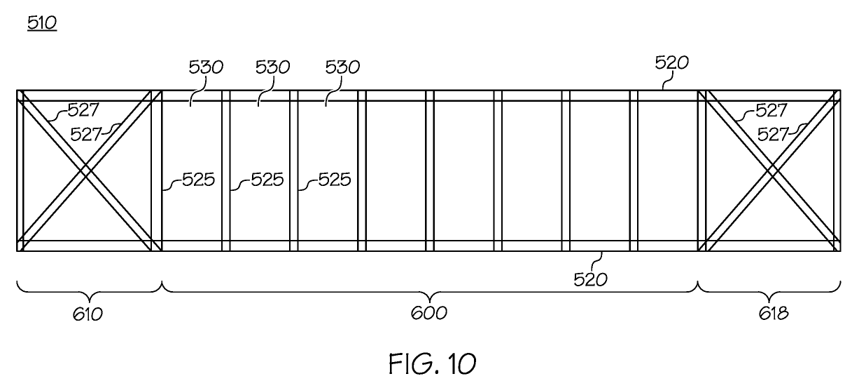

FIG. 9 is a conceptual schematic drawing depicting a trailer 500 showing loaded paired and unpaired frame structures 100. Trailer 500 includes a chassis 510 including two relatively identical and/or complementary frame rails 520 extending along a substantial portion of the length of trailer 500; said frame rails 520 at least partially separated by a gap between themselves. Such frame rails 520 are generally joined by traversing bars 525 of FIG. 10 often at ninety degrees and forty-five degree angles to frame rails 520. Paired and/or unpaired frame structures 100 may be loaded onto a trailer 500; some portions of such frame structures 100 may extend below the tops of frame rails 520 via loading ports 530 (of FIG. 10) defined by frame rails 520 and traversing bars 525 between said frame rails 520. In some embodiments not depicted, one or more of the traversing bars 525 may be absent, with one or more (paired) frame structures 100 being supported primarily by frame rails 520, preferably at longitudinal bars 340 and/or shaped corners 350 of the bottom frame structure 100 of a set of paired frame structures.

FIG. 10 depicts two frame rails 520 of a chassis 510—specifically a ladder frame chassis—with traversing bars 525 throughout underhang loading section 600, and traversing diagonal braces 527 potentially over wheels, axles, and other equipment areas. Traversing bars 525 and frame rails 520 define loading ports 530 (only some examples drawn to) throughout underhang loading section 600 with said ports being sized to allow insertion of at least some portion of frame structure 100 through a loading port 530 with frame rails 520 and/or traversing bars 525 supporting a loaded frame structure 100; while braces 527 in platform loading sections 610 and 618 are potentially over wheels, axles, and other equipment areas, do not necessarily define any port large enough for insertion of frame structure 100. Platform loading sections 610 and 618 may or may not have platform decking. Frame rails 520 and/or traversing bars 525 may supportively engage paired or unpaired frame structures 100 in baseless suspension. Additional or alternative connective means may be used to engage and/or join paired or unpaired frame structures 100 to frame rails 520 and/or traversing bars 525. In yet another embodiment, for at least a portion of underhang loading section 600, some portion of loaded frame structures 100 may hang upon, or be joined by connecting means to, frame rails 520. In yet another embodiment, frame structures 100 may be joined by connecting means to adjacently loaded frame structures 100.

By allowing insertion of at least some portion of frame structure 100 through loading ports 530, the height profile of a load of frame structures 100 and/or associated loaded trailer 500 (or some other means of transport) is generally substantial lowered thereby lowering associated centers of gravity. While current poultry transport systems consists of frame structures having no more than five-levels of cargo port openings, the lowered height profile and lowered centers of gravity of the present invention favors at least a six-row/six-layer array for cargo port openings 320 in FIG. 1. While one of the main goals of the current invention is to permit a sixth layer in a frame structure 100, some embodiments of the current invention still permit for other numbers of layers, including the traditional 5-layer system in wide use currently, or perhaps it would be preferably to have even fewer layers (e.g., three or four) for larger poultry such as grown turkeys.

The frame rails 520 of the ladder frame chassis 510 are not limited to straight shapes (e.g., the frame rails 520 may include arches or kickups, or the frame rails 520 may terminate and/or transition to another part of the trailer that substantially operates as an extension of frame rails 520 and/or a separate section of the trailer that may only be suitable to have a one level of unpaired frame structures loaded upon it—although adjacent frame structures could be joined to one another). It should be understood that the invention is not limited to the specific type of chassis, partial bed, or vehicle depicted in FIGS. 9 and 10. It should also be understood that the recitation of a frame structure or paired/joined frame structure engaged to a chassis, platform, trailer, or other singular/paired/joined frame structure is not meant to imply that no other element may be provided (such as for example, an attachment to one or both main frame rail(s) of the trailer chassis and/or associated cross-members to provide protuberances, finger-like extensions, or any other means aiding or providing fastening means).

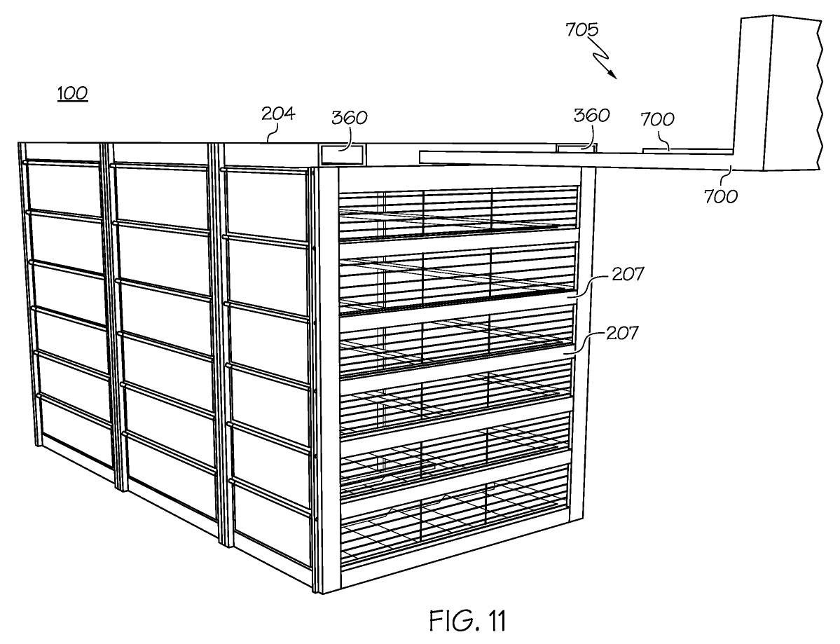

FIG. 11 is a three-dimensional side perspective drawings emphasizing frame structure top 204 of a frame structure 100 in which the forks 700 of a fork assembly 705 portion of a lifting means (i.e., a forklift generally not otherwise depicted) are preparing to engage material defining lift ports 360. Also depicted are side perspective examples of center frames 207 as an integral part of frame structure 100. In some embodiments not depicted, the fork assembly 705 may be inverted such that when placed in a lowest setting, the forks 700 are a substantial distance above the ground, thereby decreasing the subsequent distance the forks 700 need to be raised to engage lift ports 360.

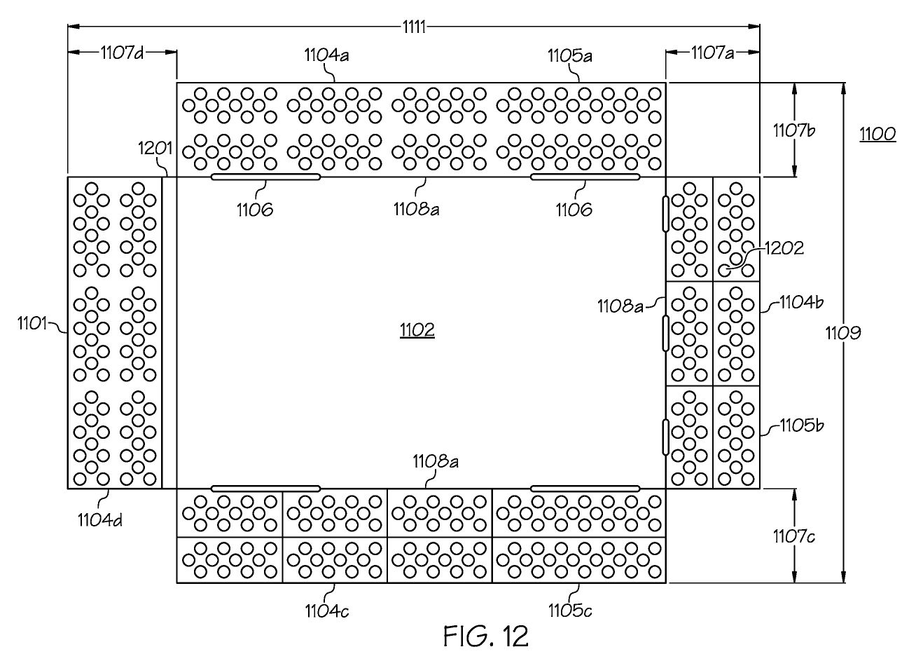

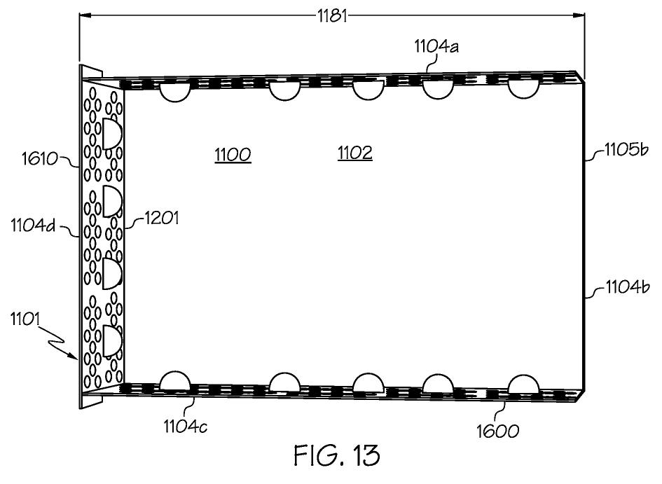

FIG. 12 depicts a diagram of an overhead view of a poultry transport cage liner 1100 with a front wall 1104d portions of which in certain modes may be integrated with a poultry transport cage door (e.g., door 1610 of FIG. 13-14) in accordance with the principles of the present invention. The poultry transport cage liner 1100 may protect live birds, with a floor 1102 also providing cushioning and support, during loading/unloading and transport operations and transitions.

The poultry transport cage liner 1100 may comprise a floor 1102 and one or more walls 1104 (e.g. walls 1104a, 1104b, 1104c, and 1104d in FIG. 12). In some embodiments, wall 1104a may be a first side wall, wall 1104b may be a back wall, wall 1104c may be a second side wall, and 1104d may be a front wall. In the example depicted in FIG. 12, the poultry transport cage liner 1100 is in an unfolded position, wherein the walls 1104a-1104d are substantially in plane with the floor 1102. The walls 1104a-1104c may be hingeably attached to the floor 1102 at hingeable connection 1108a, such as via a crease in the integral formation between the each respective wall 1104a-1104c and the floor 1102. The front wall 1104d may be hingeably attached to floor 1102 via hingeable attachment, preferably living hinge 1201 (although one possible embodiment not depicted could include another hingeable connection 1108a essentially substituted for living hinge 1201). In some embodiments, the poultry cage liner 1100 may include connecting means (e.g., tabs not depicted) to join one or more walls 1104a-1104d to an adjacent wall helping create or maintain a substantially non-planar position for one or more walls 1104a-1104d in relation to floor 1102. In some embodiments, the height 1107d of wall 1104d is approximately equal to each of the heights 1107a-1107c of perimeter wall 1104a-1104c (e.g., approximately 20 cm from hinged connections 1108afor walls 1104a-1104c and approximately 20 cm from living hinge 1201 for wall 1104d).

In some embodiments, the material of floor 1102 may define at least a portion of one or more drain slots 1106, preferably positioned at the edges of the floor 1102 in line with a hinged connection 1108awhich may allow for easier folding of the liner 1100.

A width of walls 1104a and 1104c may be substantially the length of the floor 1102. The width 1109 of the liner 1100 in the unfolded position may be 110 cm measured from the top 1105a of wall 1104a to the top 1105c of wall 1104c. The length 1111 of the liner 1100 in the unfolded position may be approximately 157 cm measured from the forward edge 1101 of front wall 1104d to the top 1105b of the back wall 1104b.

The material of walls 1104a-1104d of the poultry transport cage liner 1100 may define holes 1202. Defined holes 1202 may be sized for airflow for contained poultry. For example, embodiments include between three to six rows of holes 1202 in the walls 1104a-1104d. Further embodiments may include one row of holes 1202 in each wall 1104a-1104d. Additional embodiments even include any number and size of holes 1202 in each wall 1104a-1104d.

FIG. 13 depicts a labeled diagram of the poultry transport cage liner 1100 of FIG. 12 with walls 1104a-1104d oriented substantially perpendicular to floor 1102 preferably pointing out of the same side of a plane generally including floor 1102. Also, shown is a poultry transport cage drawer 1600 including a poultry transport cage door 1610 preferably with a means for pivoting in axial association with living hinge 1201. In some embodiments, with walls 1104a-1104d positioned substantially perpendicular on the same side of a plane generally including floor 1102, the overall length 1181 of the poultry transport cage liner 1100 from a forward edge 1101 of front wall 1104d to a top 1105b of wall 1104b may be approximately 117 cm. The height of each perimeter wall 1104a-1104d may be 20 cm, or any other height appropriate for the corresponding cage.

In some preferred embodiments, the poultry transport cage liner 1100 does not include each and every element described in FIG. 12 and FIG. 13, but may be comprised substantially of front wall 1104d, living hinge 1201, and floor 1102, or some portion(s) thereof. For example, FIG. 14 depicts a diagram of poultry transport cage drawer 1600 with poultry transport cage door 1610 integrally attached to front wall 1104d. Front wall 1104d is hingeably attached to floor 1102 via living hinge 1201, and said floor 1102 or some portion thereof is integrally attached to transport cage drawer 1600 (perimeter walls 1104a-1104c are not necessary in this embodiment; and in some embodiments a smaller front wall 1104d or a smaller portion thereof could be integral with poultry transport cage door 1610, just as a smaller floor 1102 or a smaller portion thereof could be integral with transport cage drawer 1600; with the size of living joint 1201 varying according to the availability of material and potential joinder between front wall 1104d and floor 1102.

In some preferred embodiments, polyester woven strapping 1620 serves as connective means between (1) some portion of integrated poultry transport cage door 1610 and/or front wall 1104d; and (2) some other portion of poultry transport drawer 1600 thereby potentially limiting the pivoting range of living hinge 1201. In some preferred embodiments, poultry transport cage door 1610 or integral wall 1104d may include one or more magnet(s) 1630 or other means for connecting door 1610 to some other portion of frame structure 100 or parts associated/connected to frame structure 100. Furthermore, said magnet(s) 1630 may be either fixed or suspended upon material in or connected to frame structure 100. Connective means other than the polyester woven strapping 1620 depicted in FIG. 14 may be used to limit the pivoting range of living hinge 1201 (e.g., an arm hinge).

As previously stated, the material of frame structure 100 can help define the cargo port openings 320 (See FIG. 1). Each cargo port openings 320 can receive a respective poultry transport drawer 1600, with struts 415 in FIG. 6-8 potentially helping stabilize the poultry transport drawers 1600 within frame structure 100. In some preferred embodiments, the height 1107d of front wall 1104d exceeds the height of its respective cargo port opening 320 such that one or more magnets 1630 as depicted in FIG. 14 may magnetically engage (or other connective means may engage) material in, or connected to [potentially including (an)other magnet(s)], frame structure 100 to hold poultry transport cage door 1610 in a substantially closed position as shown in FIG. 13; and when magnet 1201 is not sufficiently magnetically engaged (or other connective means is not sufficiently engaged) with material in, or connected to, frame structure 100, then the poultry transport cage door 1610 may be in the substantially open position shown in FIG. 14 with polyester woven strapping) 620, or other connective means, limiting the pivoting range of living hinge 1201.

The poultry transport cage liners 1100 with their associated living hinge 1201 and front wall 1104d integral with poultry transport cage door 1610 may comprise one or more plastics, such as corrugated fluted polypropylene (e.g. Coroplast™), or any other suitable material sufficiently flexible to permit pivoting at living hinge 1201.

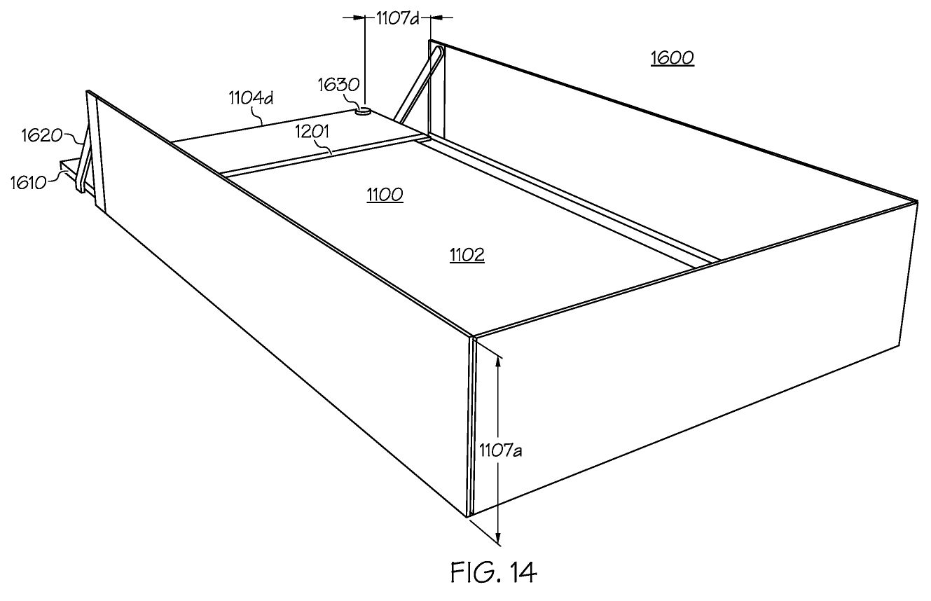

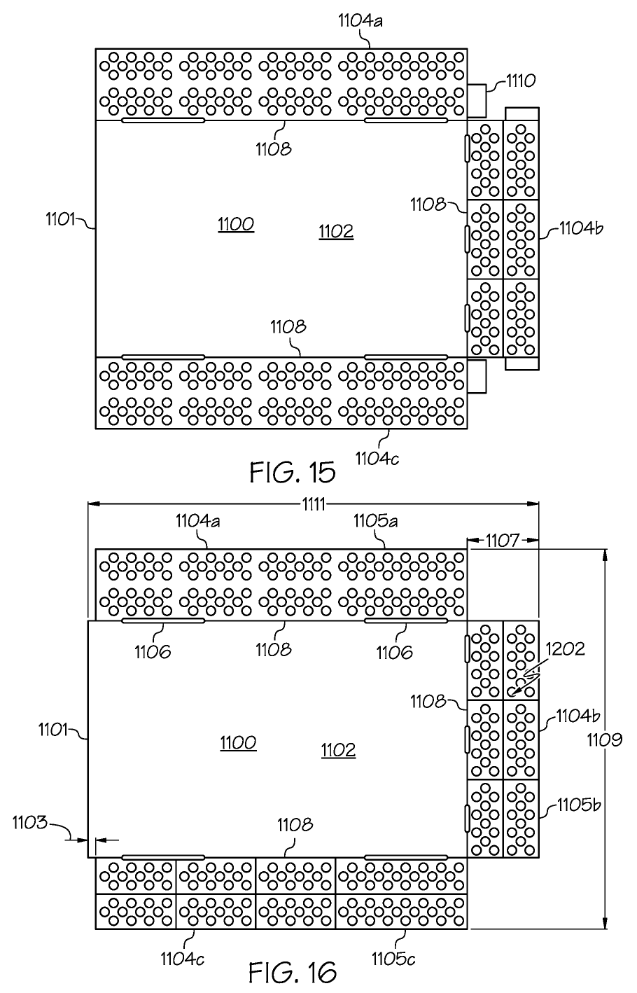

As previously stated in some preferred embodiments, the poultry transport cage liner 1100 does not include each and every element described in FIG. 12 and FIG. 13. For example, FIG. 15 depicts a diagram of an overhead view of a poultry transport cage liner 1100 in accordance with the principles of the present invention. FIG. 15 essentially depicts the poultry transport cage liner 1100 of FIG. 12 substantially without front wall 1104d or living hinge 1201, instead having a forward edge 1101 much closer to, or integral with, floor 1102. This poultry transport cage liner 1100 may likewise protect live birds during loading, transportation, and unloading from potentially hazardous containment wire (cage sides and rear), and flooring. The liner may come in a variety of sizes to fit a poultry transport cage (See reference character 3000 of FIG. 25) including potentially comprising 15 individual drawers/cells, 10 individual drawers/cells, and/or a 10 drawer/cell “broiler” cage version (having taller sides/rear). The liner may further be retrofitted to any other poultry cage presently on (or fitted to any other poultry cage which may enter) the market.

The poultry transport cage liner 1100 may comprise a floor 1102 and one or more walls 1104 (e.g. walls 1104a, 1104b, and 1104c in FIG. 15). In some embodiments, wall 1104a may be a first side wall, wall 1104b may be a back wall, and wall 1104c may be a second side wall. In the example depicted in FIG. 15, the poultry transport cage liner 1100 is in an unfolded position, wherein the walls 1104a-1104c are substantially in plane with the floor 1102. The walls 1104a-1104c may be hingeably attached to the floor 1102 at hinged connections 1108, such as via a crease in the integral formation between the each respective wall 1104a-1104c and the floor 1102. In some embodiments, the poultry cage liner 1100 may include tabs 1110 at adjacent sides of the walls 1104a-1104c such that the tabs 1110 may overlap the adjacent wall 1104a-1104c when the walls 1104a-1104c are in the upright position.

FIG. 16 depicts a labeled diagram of the poultry transport cage liner 1100 of FIG. 15. In some embodiments, the overall length 1101 of the poultry transport cage liner 1100 from a forward edge 1101 to a top 1105b of wall 1104b may be 137 cm. The height 1107 of each perimeter wall 1104a-1104(c) may be 20 cm (e.g. from the respective hinged connection 1108 to the corresponding top of the wall 1104a-1104c) or any other height appropriate for the corresponding cage.

In some embodiments, the floor 1102 may comprise one or more drain slots 1106. The drain slots 1106 may be positioned anywhere in the floor to allow for adequate waste drainage. However, positioning the drain slots 1106 at the edges of the floor 1102 may allow for drainage along and in between the walls the poultry transport cage walls. Thereby, waste draining directly onto other poultry below may be avoided. Furthermore, positioning drain slots 1106 in line with a fold, such as that of hinged connection 1108, may allow for easier folding of the liner 1100.

A width of walls 1104a and 1104c may be substantially the length of the floor 1102, except for setback 1103. Setback 1103 may be 24 mm from the forward edge 1101. The width 1109 of the liner 1100 in the unfolded position may be 110 cm measured from the top 1105a of wall 1104a to the top 1105c of wall 1104c. The length 1111 of the liner 1100 in the unfolded position may be 137 cm measured from the forward edge 1101 to the top 1105b of the back wall 1104b.

The walls 1104a-1104c of the poultry transport cage liner 1100 may further comprise holes 1202. Holes 1202 may be sized for airflow for contained/transported poultry. For example, embodiments include between three to six rows of holes 1202 in the walls 1104a-1104c. Further embodiments may include one row of holes 1202 in each wall 1104a-1104c. Additional embodiments even include any number and size of holes 1202 in each wall 1104a-1104c.

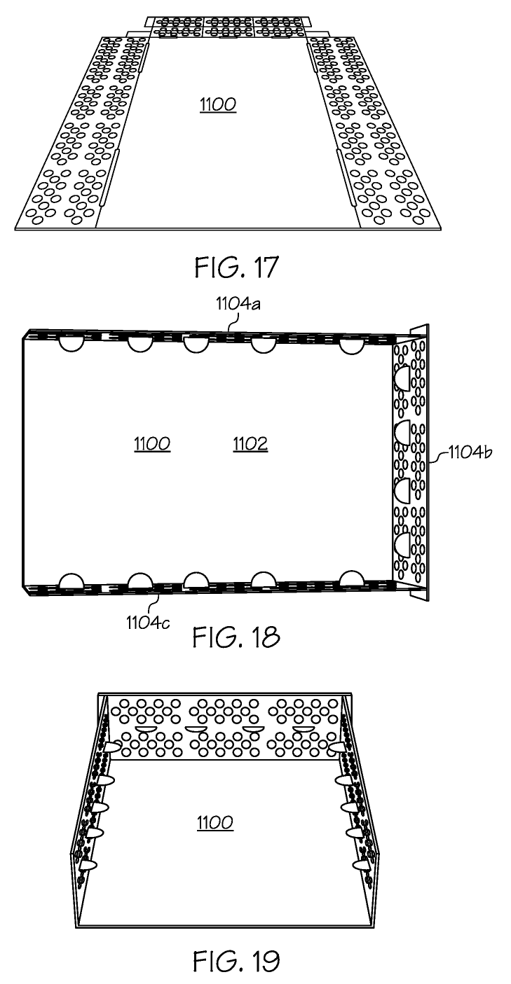

FIG. 17 depicts a diagram of an alternate overhead view of the poultry transport cage liner 1100 of FIG. 15 in accordance with the principles of the present invention.

FIG. 18 depicts a diagram of another overhead view of the poultry transport cage liner 1100 of FIG. 15 in a folded position in accordance with the principles of the present invention. The unfolded poultry transport cage liner of FIG. 15 can be folded into a folded position by folding the walls 1104a-1104c at hingeable attachment 1108 to be positioned orthogonally to the floor 1102. This folded position may be sized to fit to the interior of a poultry transport cage.

For example, the poultry transport cage liners 1100 may comprise one or more plastics, such as corrugated fluted polypropylene (e.g. Coroplast™), or any other thermally insulating material sufficient to prevent birds from freezing to the liner with sufficient tensile strength to support the weight of at least one bird poultry. Such material may be placed as a liner on the inside of a poultry transport cage such that a bird poultry placed inside the liner may be prevented from touching the metal of the cage. In embodiments wherein, the liner is a thermal insulator, the feet of any birds or poultry inside the liner may be prevented from freezing to the cage.

The material of the poultry transport cage liners may further provide sufficient flexibility such that the liner may be inserted into a broken cage. For example, if a cage has broken metal wire pointing into the interior of the cage, the poultry transport cage liner may have sufficient flexibility to deform over the wire with the poultry transport cage liner fully in the cage.

The material of the poultry transport cage liners may also provide tensile strength sufficient to support the weight of one to any number of poultry placed inside the poultry transport cage liner after installation of the liner into the poultry transport cage. For example, an aging poultry transport cage may develop holes as the wire breaks. Upon installation, the poultry transport cage liner may cover the holes and support the weight of any contained birds. In further example, the poultry transport cage may not necessarily have a bottom. In these embodiments, the liner perimeter walls may be anchored to the sides of the cage and the bottom of the liner may be suspended from the liner perimeter walls by integral formation or attachment to the cage perimeter walls.

FIG. 19 depicts an alternate view of the poultry transport cage liner of FIG. 18.

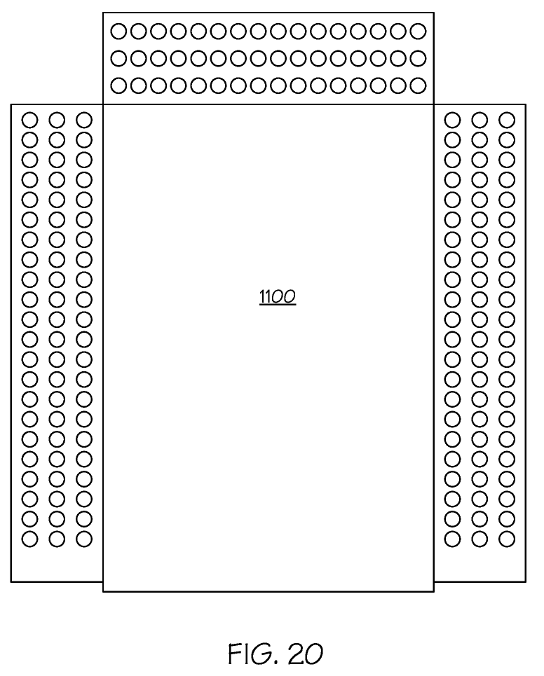

FIG. 20 depicts the poultry transport cage liner of FIG. 16.

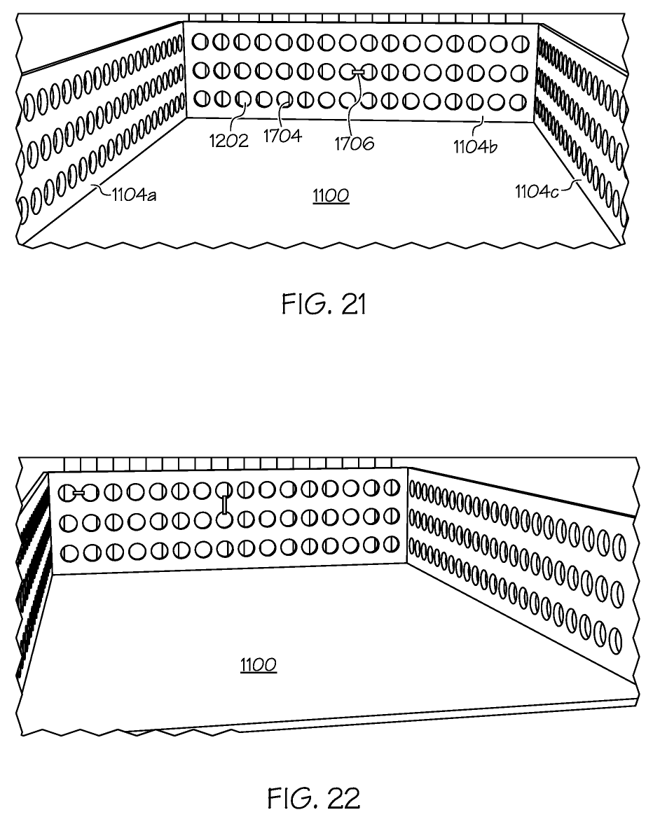

FIG. 21 depicts the poultry transport cage liner of FIG. 20 placed into a poultry cage in accordance with the principles of the present invention. As can be seen, the floor 1102 may cover the floor of the poultry transport cage, such as any exposed metal. The holes 1202 may allow air flow through the poultry transport cage liner 1100. For example, metal wire 1704 of the poultry transport cage may be exposed through one or more holes 1202. The poultry transport cage liner 1100 may be attached to the poultry transport cage 3000 (of FIG. 25) by an attachment 1706. For example, the attachment 1706 may comprise a fastening tie looped around the metal wire 1704 and through two holes 1202 in a wall 1104a-1104c. The binding of the poultry transport cage liner 1100 to the frame structure 100 by one or more attachments 1706 may provide the poultry transport cage liner 1100 with sufficient integrity to support the weight of one or more birds due to the integrity of the poultry transport cage liner 1100. In some embodiments, the underlying cage may also support the poultry transport cage liner 1100.

FIG. 22 depicts an additional view of the poultry transport cage liner of FIG. 21.

FIGS. 23 and 24 depict openwork in the form of cagework 1725 although any number of openworks could be utilized in the current invention including wireworks, grillwork, perforated walls, or any other openworks system designed to permit airflow and ventilation for poultry confined to cells. Furthermore, this openworks systems might not only be present on the outer parameters of the frame structure but internally as well, with said frame structure 100 and cagework 1725 (or other openworks) generally helping defining cells for containing poultry during transport. Insertable drawers (e.g., drawer 1600) and/or doors (e.g., door 1610) and/or poultry transport cage liners 1100 may also help define cells for containing poultry during loading/unloading/transport operations.

FIG. 23 depict the binding of the poultry transport cage liner of FIG. 21 to a poultry transport cage 1902 in accordance with the principles of the present invention. The attachment 1706 may comprise a fastening tie looped through holes 1202 in the wall 1104a-1104c and around the wire 1704 of the poultry transport cage 1902.

FIG. 24 depicts multiple poultry transport cage liners in respective cells of a multi-cell poultry transport cage in accordance with in the principles of the present invention.

FIG. 25 depicts one preferred embodiment of a multi-cell poultry transport cage 3000.

FIG. 26 depicts a perimeter wall 1202 of an alternate poultry transport cage liner 1200 in accordance with the principles of the present invention. The perimeter wall 1202 may comprise a first side wall 1204a, a back wall 1204b, and a second side was 1204c. The first side wall 1204a may be hingeably attached to the back wall 1204b at hinged connection 1208. The poultry transport cage liner 1200 and/or the perimeter wall 1202 may comprise materials similar to those of the poultry transport cage liner 1100. The second side wall 1204c may be hingeably attached to the back wall 1204b at hinged connection 1208. The hinged connection 1208 may be integrally formed with the walls 1204a-1204c. In these embodiments, the hinged connection 1208 may comprise a crease or a fold in the material of the perimeter wall 1202. Alternatively, the poultry transport cage liner 1100 may be separate wall sections and separate floor or any combination thereof.

The perimeter wall 1202 may have a height of about 20.3 cm. The first side wall 1204a and the second side wall 1204c may have a length of about 111.7 cm. The holes 1210 may be about 3.2 cm in diameter. In other embodiments, the holes 1210 may be about 3.2 cm in radius. The holes 1210 may be substantially similar to holes 1202, and vice versa.

The perimeter wall 1202 may further comprise a flange 1206. The flange 1206 may extend inwardly and/or outwardly about 7.0 inches orthogonally from a bottom of the perimeter wall 1202. The flange 1206 may otherwise be sized for receiving an interchangeable liner floor when the perimeter wall 1202 is in the folded position.

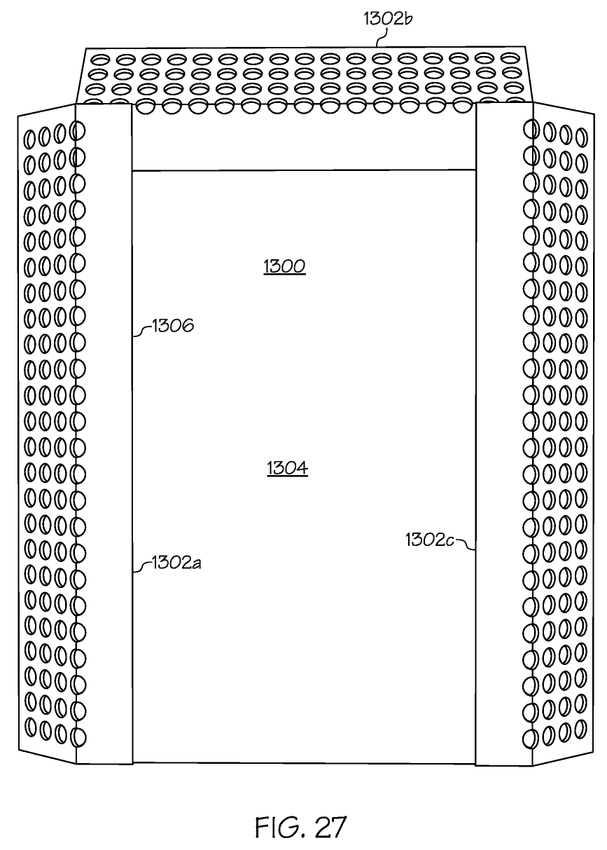

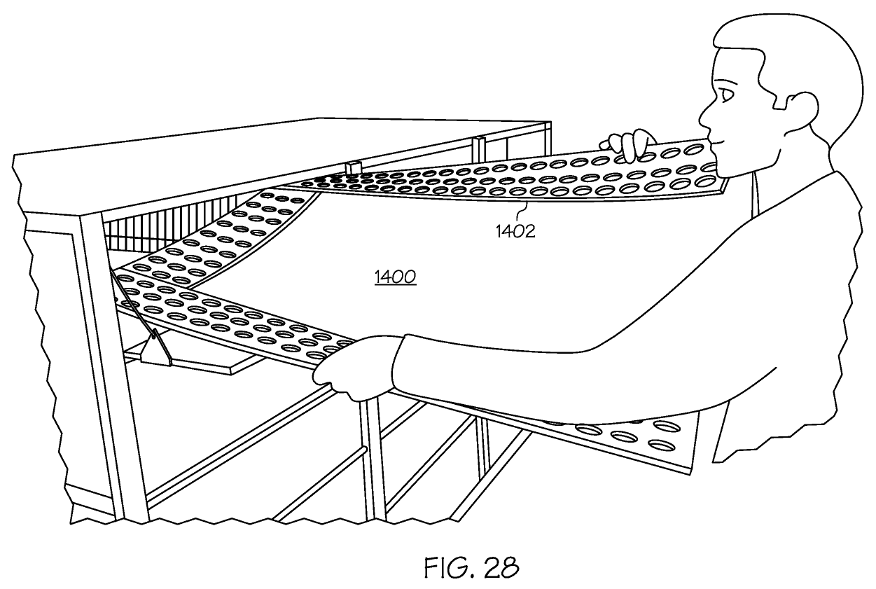

FIG. 27 depicts an alternate perimeter wall 1302 made up of wall sections 1302a, 1302b, and 1302c (and potentially associated flange 1306) attached to an interchangeable liner floor 1304 in accordance with the principles of the present invention. The sizing of the respective wall sections 1302a-1302c may be substantially similar to the sizing of the wall sections 1204a-1204c of the perimeter wall 1202. The alternate perimeter wall 1302 may comprise a first side wall 1302a, a back wall 1302b, and a second side wall 1302c, in separate sections. The perimeter wall 1302 may further comprise a flange 1306 that is substantially similar to the flange 1206. Thus, the flange 1306 may support the interchangeable liner floor 1304. As such, the interchangeable liner floor 1304 may be temporarily attached to the perimeter wall 1302a-1302c, such as by wire, pins, zip tie, nails, etc.

FIG. 28 depicts installation of a poultry transport cage liner 1400 into a poultry transport cage in accordance with the principles of the present invention. As can be seen, the perimeter wall 1402 may be folded against the floor 1400 beyond the orthogonal folded position previously depicted. The poultry transport cage liner 1400 can then be inserted into the poultry transport cage. After insertion, the perimeter wall 1402 may be released to the orthogonal folded position depicted above. Then, the liner 1400 may be fastened to the cage with the fastening method of choice, such as the fastening ties described with respect to FIG. 21.

FIGS. 11 and 23-25 best depict the openworks aspect of the system permitting airflow.

Discussions of preferred embodiments are not intended to exclude other possibilities, including, but not limited to, the number of columns of drawers, the presence of a platform on at least some portion of the trailer chassis; frame structure(s) connecting to a platform bed, frame chassis or other chassis, or parts attached to a platform bed or chassis (e.g., an outer framing structure, or end walls (or approximating equivalents such as corner posts/flippers) such as those used on flat-track containers; or different types of trailers (e.g., gooseneck trailer, step deck trailer, low boy trailer preferably made of lightweight material as compared to often heavy material used to haul very heavy equipment/loads, extendable/expandable trailer); or the possibility of more than two or simply one frame structure forming the equivalent or a substitute to a paired frame structure that is engageable to a chassis/platform or such attachment thereto; or the possibility that in a paired/joined frame structure of two or more frame structures, the tops or bottoms of individual frame structures in a paired/joined frame structure could have multiple combinations of recesses or protrusions provided one or more of them engages another recess or protrusion in an adjoining frame structure.

Nor is the recitation of an openworks intended to prohibit at least a portion of a boundary of the frame structure having a wall-like form rather than openworks. Nor is discussion of a liner with a living hinge utilizing magnetics intended to exhaust the manner in which the door may be moved from an open to closed conditions; for example, a piano hinge, push open push close mechanism, or tensioned spring may be utilized to help bias the door open and/or closed. Nor are given examples of material the poultry transport cage liner intended to limit what material may be utilized as different users may wish to use different materials emphasizing different applications; for example, some users may wish to utilize very cheap paper-like material potentially disposable after each transport cycle while others may wish to use more durable material that can be periodically cleaned with multiple lifetime transport cycles before replacement.

Traditionally, frame structures and their associated openworks and doors have been composed mainly of metal. However, in some embodiments of the aforementioned systems, much of the frame structure and/or openworks and/or door may be composed of plastic, other polymers, combined polymers, and/or combined polymers and non-polymeric materials, suitable for load-bearing adequate to contain and transport poultry. Also, the aforementioned systems may have much/most of their frame structure and/or openworks and/or door composed of lightweight plastic, other combined polymers, and or combined polymers and non-polymeric materials while other portions of the frame structure and/or openworks and/or door (especially outer portions of the frame structure) may be composed of a lightweight metal (e.g., aluminum) wherein the lightweight metal component(s) have more desirable strength/wear qualities than if they were made of plastic or other non-metal material.

We claim:

1. A poultry transport system comprising at least one frame structure configurable for baseless suspension said at least one frame structure having at least one load-bearing layer.

2. The poultry transport system of claim 1 further comprising:
a transport vehicle comprising at least two frame rails at least some portion(s) of which are separated by a gap wherein the at least one frame structure is configurable for baseless suspension from the at least two frame rails.

3. The poultry transport system of claim 2 further comprising at least two traversing bars between at least two of the at least two frame rails, said frame rails and at least two traversing bars defining at least one loading port configured for insertion of a frame structure bottom of the at least one frame structure.

4. The poultry transport system of claim 1 wherein the at least one load-bearing layer comprises at least six load-bearing layers.

5. A poultry transport system comprising:
a frame structure configurable to transport poultry comprising;
at least two frame structure sides;
at least two frame structure ends.
a frame structure top;
a frame structure bottom;
openworks joined to the frame structure said openworks configurable for permitting airflow, wherein said frame structure and openwork at least partially define a cell configured for containing poultry during transport and at least one cargo port opening leading to a cell for containing poultry during transport.

6. The poultry transport system of claim 5 wherein the frame structure further comprises at least six load-bearing layers.

7. The poultry transport system of claim 5 wherein the frame structure generally defines a rectilinear box.

8. The poultry transport system of claim 5 wherein the frame structure and openwork comprise at least one vertical member at least partially defining at least two columns of cargo port openings with respective associated cells within the frame structure.

9. The poultry transport system of claim 5 wherein the frame structure is configured to support drawers inserted into respective cargo port openings.

10. The poultry transport system of claim 5 wherein the frame structure top comprises at least one longitudinal member defining a recess engageable by lifting means.

11. The poultry transport system of claim 5 wherein the frame structure top of one frame structure is shaped and/or frictionally engageable for pairing with a frame structure bottom of another frame structure thereby forming paired frame structures.

12. The poultry transport system of claim 5 further comprising:
a door associated with respective cargo port openings wherein the door is configured to be biased and securable to prevent the unintentional exit of poultry once inserted into a cell for transport.

13. The poultry transport system of claim 12 wherein the door comprises at least one magnet engageable with material in or connected to the frame structure.

14. The poultry transport system of claim 12 wherein the door comprises openworks.

15. The poultry transport system of claim 12 wherein the door comprises a hinge.

16. The poultry transport system of claim 12 wherein the door is part of a respective drawer generally configured to be insertable into a respective cargo port opening.

17. The poultry transport system of claim 16 wherein the door is integral with a front section of a poultry transport cage liner.

18. The poultry transport system of claim 16 wherein the door and/or drawer is integral with and/or comprised of a portion of a poultry transport cage liner.

19. The poultry transport system of claim 5 further comprising a poultry transport cage liner.

20. The poultry transport system of claims 19 wherein the poultry transport cage liner is comprised of thermally insulating material.

21. The poultry transport system of claim 19 wherein the poultry transport cage liner comprises a floor section.

22. The poultry transport system of claim 21 wherein the poultry transport cage liner further comprises at least one wall section.

23. The poultry transport system of claim 22 wherein the poultry transport cage liner further comprises holes defined by the at least one wall sections.

24. The poultry transport system of claim 22 wherein drainage slots are defined by the floor section and/or the at least one wall sections.

25. The poultry transport system of claim 22 wherein the at least one wall section comprises at least two wall sections.

26. The poultry transport system of claim 25 wherein the at least two wall sections comprises at least four wall sections, wherein the floor section and four wall sections are configurable to form the general shape of an open-top box.

27. The poultry transport system of claim 25 wherein the poultry transport cage liner further comprises means for fastening at least one wall section to at least one other adjacent wall section.

28. The poultry transport system of claim 27 wherein the means for fastening comprise one or more tabs engagable with at least one other adjacent wall section.

29. The poultry transport system of claim 18 wherein the poultry transport cage liner comprises a living hinge.

30. The poultry transport system of claim 29 wherein the door further comprises at least one magnet engageable with material in or connected to the frame structure.

31. The poultry transport system of claim 22 wherein the poultry transport cage liner is configurable to generally lie within a plane and is foldable to where the at least one wall sections is substantially perpendicular to the floor section.

32. A method for poultry transport comprising the steps of:
placing poultry within cells defined within a frame structure;
inserting a frame structure bottom of an at least one frame structure through a gap at least partially defined by at least two frame rails comprising part of a transport vehicle; and
suspending the frame structure from the at least two frame rails in a baseless configuration.

33. The method for poultry transport of claim 32 further comprising the step of placing a poultry transport cage liner within a cell within a frame structure.

34. The method for poultry transport of claim 32 further comprising the step of engaging the top of a first frame structure with the bottom of a second frame structure.

35. The method for poultry transport of claim 32 wherein the step of placing poultry within cells defined within a frame structure further comprises placing poultry within cells contained in at least six load-bearing layers within the frame structure.
